(19) United States
(12) Patent Application Publication
(10) Pub. No.: US 2023/0174180 A1
(43) Pub. Date: Jun. 8, 2023

(54) Motorcycle Securing Assembly

(71) Applicants: Joel Kalista, Winlock, WA (US); Paul Hope, Winlock, WA (US)

(72) Inventors: Joel Kalista, Winlock, WA (US); Paul Hope, Winlock, WA (US)

(21) Appl. No.: 17/545,048

(22) Filed: Dec. 8, 2021

(51) Int. Cl. B62H 3/00; B66F 7/28

(52) U.S. Cl. CPC B62H 3/00; B66F 7/28

(57) ABSTRACT

A motorcycle securing assembly includes a first clamp which is fixedly mounted to a lift platform. A locking unit is attached to the lift platform and the locking unit is spaced from the first clamp on the lift platform. The locking unit is actuatable in a first condition having the locking unit travelling toward the first clamp. Conversely, the locking unit is actuatable in a second condition has the locking unit travelling away from the first clamp. A second clamp is coupled to the locking unit. The second clamp moves toward the first clamp when the locking unit is actuated into the first condition to compress a front tire of a motorcycle between the first clamp and the second clamp to secure the motorcycle on the lift platform.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to securing devices and more particularly pertains to a new securing device for securing a motorcycle to a lift platform. The device includes a first clamp which is fixed to the lift platform. The device includes a locking unit that is mounted to the platform and a second clamp that is disposed on the locking unit. The second clamp is urged toward the first clamp when the locking unit is actuated into a locking condition to compress a front tire of a motorcycle between the first clamp and the second clamp.

### (2) Description of Related Art including information disclosed under 37 CFR 1.97 and 1.98

The prior art relates to securing devices including a variety of lift devices for lifting a two wheeled vehicle for service. The prior art discloses a wheel clamp device that includes a platform upon which a front tire of a motorcycle can be positioned and a pair of arms which each compresses against the front tire to secure the motorcycle on in an upright orientation. The prior art discloses an ornamental design of a wheel clamping device that includes a pair of L-shaped clamps and a hand crank for urging the L-shaped clamps toward each other to secure a wheel of a vehicle.

### BRIEF SUMMARY OF THE INVENTION

An embodiment of the disclosure meets the needs presented above by generally comprising a first clamp which is fixedly mounted to a lift platform. A locking unit is attached to the lift platform and the locking unit is spaced from the first clamp on the lift platform. The locking unit is actuatable in a first condition having the locking unit travelling toward the first clamp. Conversely, the locking unit is actuatable in a second condition has the locking unit travelling away from the first clamp. A second clamp is coupled to the locking unit. The second clamp moves toward the first clamp when the locking unit is actuated into the first condition to compress a front tire of a motorcycle between the first clamp and the second clamp to secure the motorcycle on the lift platform.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a motorcycle securing assembly according to an embodiment of the disclosure.

FIG. 2 is a right side phantom view of an embodiment of the disclosure.

FIG. 3 is a front view of an embodiment of the disclosure showing the relative motion of a locking unit.

FIG. 4 is a bottom view of an embodiment of the disclosure.

FIG. 5 is a perspective in-use view of an embodiment of the disclosure.

### DETAILED DESCRIPTION OF THE INVENTION

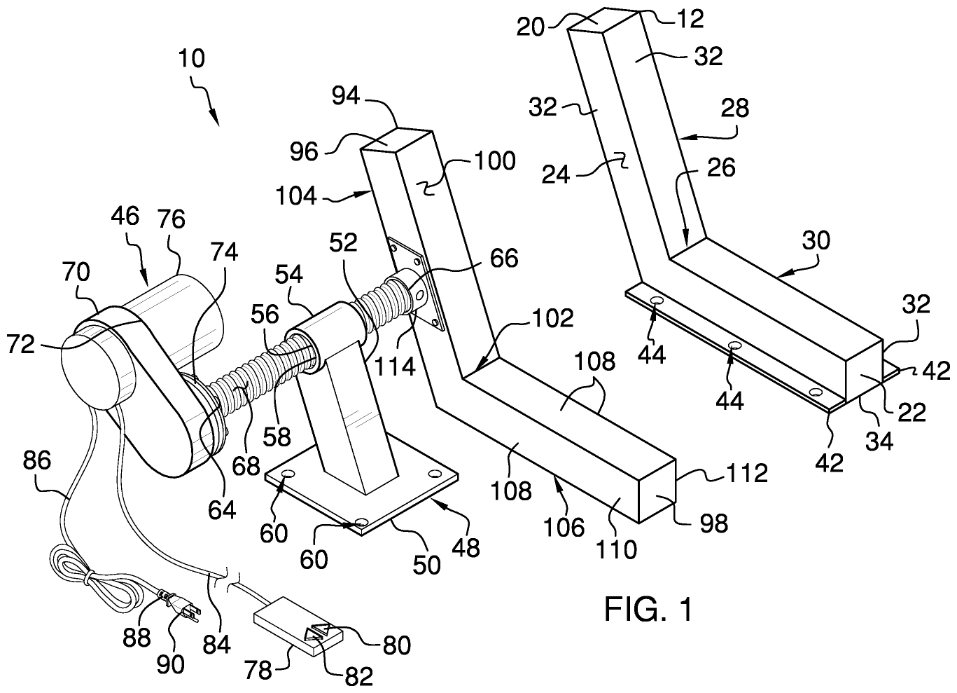

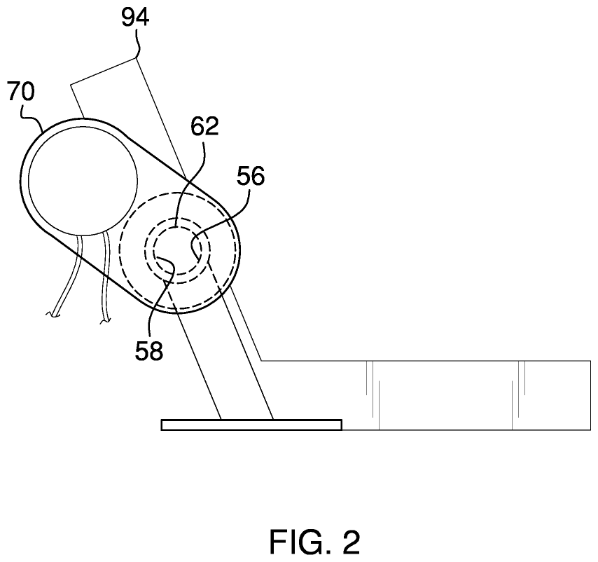

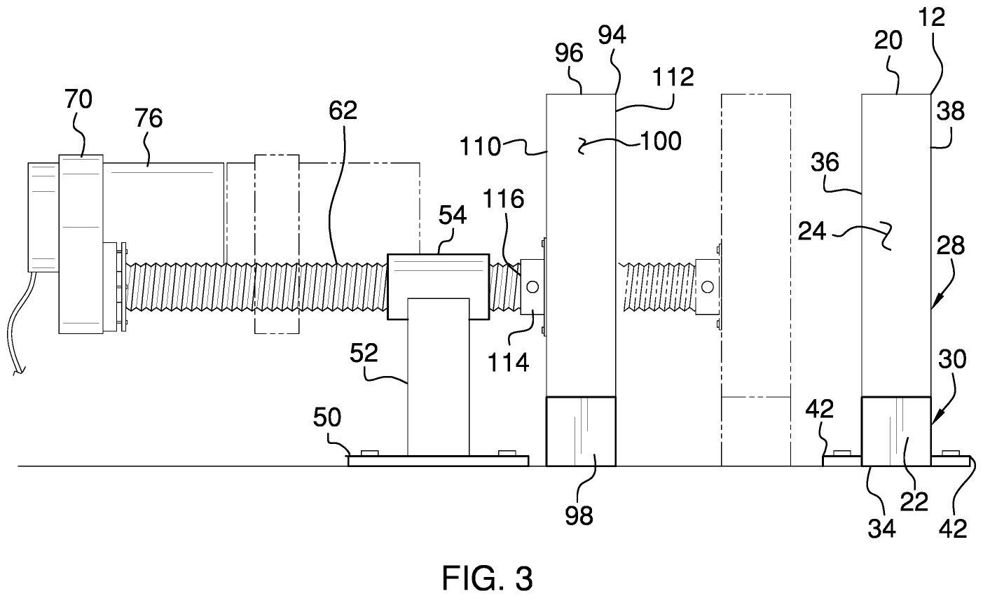

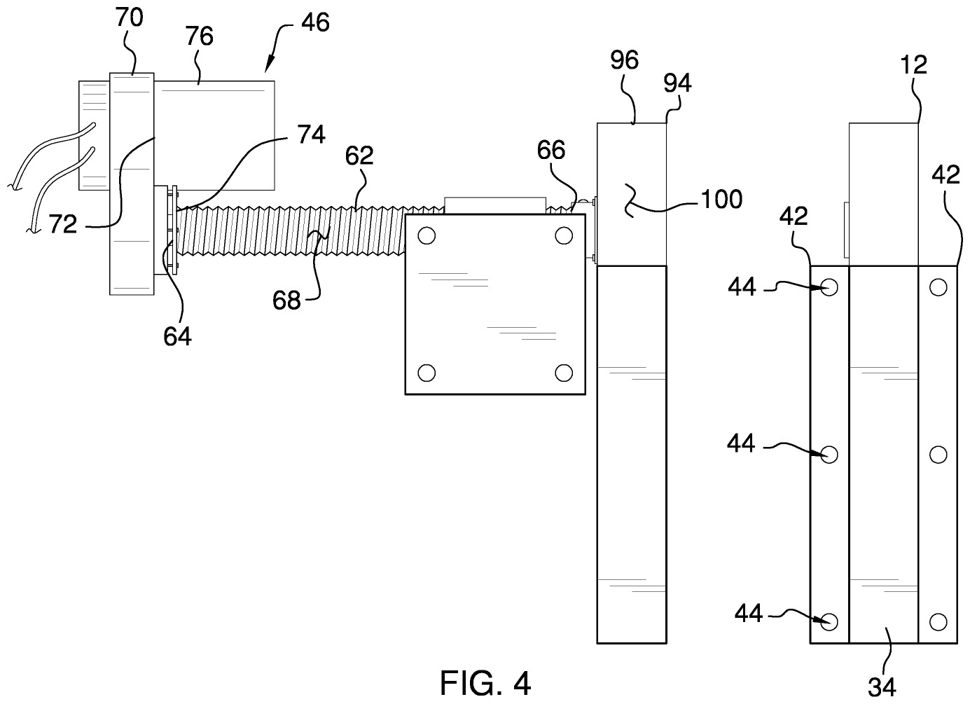

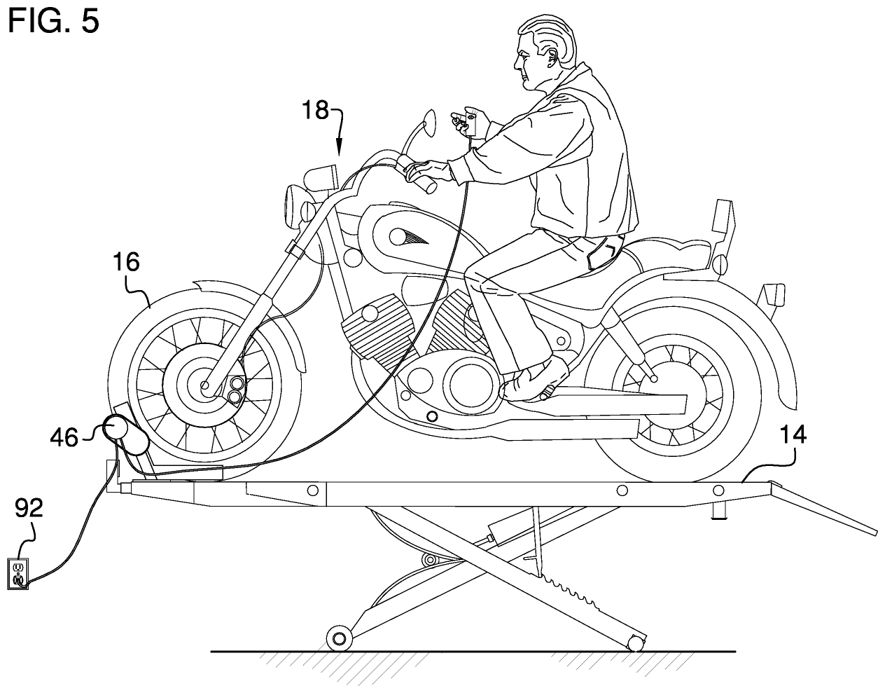

With reference now to the drawings, and in particular to FIGS. 1 through 5 thereof, a new securing device embodying the principles and concepts of an embodiment of the disclosure and generally designated by the reference numeral 10 will be described.

As best illustrated in FIGS. 1 through 5, the motorcycle securing assembly 10 generally comprises a first clamp 12 that is fixedly mounted to a lift platform 14. In this way a front tire 16 of a motorcycle 18 can be positioned against the first clamp 12 when the motorcycle 18 is driven onto the lift platform 14. The lift platform 14 may be a component of a motorcycle lift that might commonly be employed in a motorcycle service business or the like. The first clamp 12 has a first end 20, a second end 22 and an outer surface 24 extending between the first end 20 and the second end 22. The first clamp 12 has a bend 26 defining a first portion 28 which forms an angle with a second portion 30, and the bend 26 is centrally positioned between the first end 20 and the second end 22. The first portion 28 is associated with the first end 20 and the second portion 30 is associated with the second end 22.

The outer surface 24 has a plurality of intersecting sides 32 such that the first clamp 12 has a rectangular shape. Additionally, the plurality of intersecting sides 32 includes a bottom side 34, a first lateral side 36 and a second lateral side 38. The bottom side 34 rests on the lift platform 14 having the first portion 28 angling upwardly from the lift platform 14. In this way each of the first portion 28 and the second portion 30 can rest against a sidewall 40 of the front tire 16. The outer surface 24 has a pair of lips 42 each extending laterally away from a respective one of the first lateral side 36 and the second lateral side 38. Each of the lips 42 is aligned with the bottom side 34 such that each of the lips 42 rests on the lift platform 14. Furthermore, each of the lips 42 has a plurality of fastener holes 44 to receive a fastener for securing the first clamp 12 to the lift platform 14.

A locking unit 46 is attached to the lift platform 14 and the locking unit 46 is spaced from the first clamp 12 on the lift platform 14. The locking unit 46 is actuatable in a first condition having the locking unit 46 travelling toward the first clamp 12. Conversely, the locking unit 46 is actuatable in a second condition having the locking unit 46 travelling away from the first clamp 12. The locking unit 46 comprises a stand 48 that has a base 50 and a member 52 angling upwardly from the base 50. The base 50 rests on the lift platform 14 having the member 52 being vertically oriented on the lift platform 14. The member 52 has a distal end 54 with respect to the base 50.

The member 52 has an aperture 56 extending through the member 52 and the aperture 56 is positioned adjacent to the distal end 54. The aperture 56 extends along an axis that is oriented perpendicular to an axis extending between the distal end 54 and the base 50. The aperture 56 has a bounding surface 58 and the bounding surface 58 is threaded. Additionally, the base 50 has a plurality of holes 60 extending through the base 50 which can each receive a respective fastener for securing the base 50 to the lift platform 14.

The locking unit 46 includes a screw 62 that has a primary end 64, a secondary end 66 and an outside surface 68 extending between the primary end 64 and the secondary end 66. The screw 62 extends through the aperture 56 has the outside surface 68 threadably engaging the bounding surface 58 of the aperture 56. The base 50 is oriented such that the secondary end 66 of the screw 62 is directed toward the first clamp 12. The locking unit 46 includes a drive unit 70 which has an input 72 and an output 74. The output 74 is coupled to the primary end 64 of the screw 62 and the output 74 is in mechanical communication with the input 72. The drive unit 70 may comprise a gear drive or other type of type of mechanical drive which includes a housing, a input and an output.

The locking unit 46 includes a motor 76 that is coupled to the input 72 of the drive unit 70. The output 74 is rotated in a first direction when the motor 76 is actuated into a first condition such that the screw 62 travels through the aperture 56 toward the first clamp 12. Conversely, the output 74 is rotated in a second direction when the motor 76 is actuated into a second condition such that the screw 62 travels through the aperture 56 away from the first clamp 12. The motor 76 may comprise an electric motor or other type of bi-directional motor.

The locking unit 46 includes a control 78 that is electrically coupled to the motor 76, and the control 78 has a first button 80 and a second button 82. The motor 76 is actuated into the first condition when the first button 80 is depressed, and the motor 76 is actuated into the second condition when the second button 82 is depressed. The control 78 includes a conductor 84 that is electrically coupled between the control 78 and the motor 76 thereby facilitating the control 78 to be remotely positioned with respect to the motor 76. The locking unit 46 includes a power cord 86 that is electrically coupled to and extends away from the motor 76. The power cord 86 has a distal end 88 with respect to the motor 76 and a male plug 90 is electrically coupled to the distal end 88 of the power cord 86 which can be plugged into a power source 92 comprising a female electrical outlet.

A second clamp 94 is provided and the second clamp 94 is coupled to the locking unit 46. The second clamp 94 moves toward the first clamp 12 when the locking unit 46 is actuated into the first condition. In this way the front tire 16 of the motorcycle 18 is compressed between the first clamp 12 and the second clamp 94 to secure the motorcycle 18 on the lift platform 14. Conversely, the second clamp 94 moves away from the first clamp 12 when the locking unit 46 is actuated into the second condition. In this way the second clamp 94 disengages the front tire 16 of the motorcycle 18 thereby facilitating the front tire 16 to roll freely on the lift platform 14.

The second clamp 94 has a first end 96, a second end 98 and an outer surface 100 extending between the first end 96 and the second end 98 of the second clamp 94. The second clamp 94 has a bend 102 defining a first portion 104 forming an angle with a second portion 106. Furthermore, the bend 102 on the second clamp 94 is centrally positioned between the first end 96 and the second end 98 of the second clamp 94. The first portion 104 of the second clamp 94 is associated with the first end 96 of the second clamp 94 and the second portion 106 of the second clamp 94 is associated with the second end 98 of the second clamp 94. The outer surface 100 of the second clamp 94 has a plurality of intersecting sides 108 such that the second clamp 94 has a rectangular shape, and the plurality of intersecting sides 108 includes a first lateral side 110 and a second lateral side 112.

A receiver 114 is provided and the receiver 114 is coupled to the first lateral side 110 of the outer surface 100 of the second clamp 94. The receiver 114 is centrally positioned between the bend 102 on the second clamp 94 and the first end 96 of the second clamp 94. Additionally, the receiver 114 has a distal end 116 with respect to the first lateral side 110 of the outer surface 100 of the second clamp 94. The distal end 116 of the receiver 114 is open and the distal end 116 of the receiver 114 insertably receives the secondary end 66 of the screw 62. Moreover, the receiver 114 rotatably engages the secondary end 66 such that the screw 62 is rotatable in the receiver 114.

In use, the motorcycle 18 is driven onto the lift platform 14 until the front tire 16 is positioned between the first clamp 12 and the second clamp 94. The first button 80 on the control 78 is depressed to compress the front tire 16 between the first clamp 12 and the second clamp 94. In this way the motorcycle 18 is secured in an upright position on the lift platform 14. The second button 82 is depressed to release the front tire 16 from the first clamp 12 and the second clamp 94. In this way the motorcycle 18 can be driven off of the lift platform 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A motorcycle securing assembly for securing a motorcycle on a lift, said assembly comprising:
a first clamp being fixedly mounted to a lift platform wherein said first clamp is configured to have a front tire of a motorcycle positioned against said first clamp when the motorcycle is driven onto the lift platform;
a locking unit being attached to the lift platform, said locking unit being spaced from said first clamp on the lift platform, said locking unit being actuatable in a first condition having said locking unit travelling toward said first clamp, said locking unit being actuatable in a second condition having said locking unit travelling away from said first clamp; and
a second clamp being coupled to said locking unit, said second clamp moving toward said first clamp when said locking unit is actuated into said first condition wherein said second clamp is configured to compress the front tire of the motorcycle between said first clamp and said second clamp to secure the motorcycle on the lift platform, said second clamp moving away from said first clamp when said locking unit is actuated into said second condition wherein said second clamp is configured to disengage the front tire of the motorcycle thereby facilitating the front tire to roll freely on the lift platform.

2. The assembly according to claim 1, wherein:
said first clamp has a first end, a second end and an outer surface extending between said first end and said second end, said first clamp having a bend defining a first portion forming an angle with a second portion, said bend being centrally positioned between said first end and said second end, said first portion being associated with said first end, said second portion being associated with said second end, said outer surface having a plurality of intersecting sides such that said first clamp has a rectangular shape, said plurality of intersecting sides including a bottom side, a first lateral side and a second lateral side;
said bottom side rests on the lift platform having said first portion angling upwardly from said lift platform wherein each of said first portion and said second portion are configured to rest against a sidewall of the front tire; and
said outer surface has a pair of lips each extending laterally away from a respective one of said first lateral side and said second lateral side, each of said lips being aligned with said bottom side such that each of said lips rests on the lift platform, each of said lips having a plurality of fastener holes wherein each of said fastener holes is configured to receive a fastener to secure said first clamp to the lift platform.

3. The assembly according to claim 1, wherein said locking unit comprises a stand having a base and a member angling upwardly from said base, said base resting on the lift platform having said member being vertically oriented on the lift platform, said member having a distal end with respect to said base, said member having an aperture extending through said member, said aperture being positioned adjacent to said distal end, said aperture extending along an axis being oriented perpendicular to an axis extending between said distal end and said base, said aperture having a bounding surface, said bounding surface being threaded, said base having a plurality of holes extending through said base wherein each of said holes in said base is configured to receive a respective fastener for securing said base to the lift platform.

4. The assembly according to claim 3, wherein said locking unit includes a screw having a primary end, a secondary end and an outside surface extending between said primary end and said secondary end, said screw extending through said aperture having said outside surface threadably engaging said bounding surface of said aperture, said base being oriented such that said secondary end of said screw is directed toward said first clamp.

5. The assembly according to claim 4, wherein said locking unit includes a drive unit having an input and an output, said output being coupled to said primary end of said screw, said output being in mechanical communication with said input.

6. The assembly according to claim 5, wherein said locking unit includes a motor being coupled to said input of said drive unit, said output being rotated in a first direction when said motor is actuated into a first condition such that said screw travels through said aperture toward said first clamp, said output being rotated in a second direction when said motor is actuated into a second condition such that said screw travels through said aperture away from said first clamp.

7. The assembly according to claim 6, wherein said locking unit includes a control being electrically coupled to said motor, said control having a first button and a second button, said motor being actuated into said first condition when said first button is depressed, said motor being actuated into said second condition when said second button is depressed.

8. The assembly according to claim 6, wherein said locking unit includes a power cord being electrically coupled to and extending away from said motor, said power cord having a distal end with respect to said motor, said distal end having a male plug being electrically coupled thereto wherein said male plug is configured to be plugged into a power source comprising a female electrical outlet.

9. The assembly according to claim 1, wherein said second clamp has a first end, a second end and an outer surface extending between said first end and said second end of said second clamp, said second clamp having a bend defining a first portion forming an angle with a second portion, said bend on said second clamp being centrally positioned between said first end and said second end of said second clamp, said first portion of said second clamp being associated with said first end of said second clamp, said second portion of said second clamp being associated with said second end of said second clamp, said outer surface of said second clamp having a plurality of intersecting sides such that said second clamp has a rectangular shape, said plurality of intersecting sides including a first lateral side and a second lateral side.

10. The assembly according to claim 9, wherein:
said locking unit includes a screw having a primary end and a secondary end; and
said assembly includes a receiver being coupled to said first lateral side of said outer surface of said second clamp, said receiver being centrally positioned between said bend on said second clamp and said first end of said second clamp, said receiver having a distal end with respect to said first lateral side of said outer surface of said second clamp, said distal end of said receiver being open, said distal end of said receiver receiving said secondary end of said screw, said receiver rotatably engaging said secondary end such that said screw is rotatable in said receiver.

11. A motorcycle securing assembly for securing a motorcycle on a lift, said assembly comprising:
a first clamp being fixedly mounted to a lift platform wherein said first clamp is configured to have a front tire of a motorcycle positioned against said first clamp when the motorcycle is driven onto the lift platform, said first clamp having a first end, a second end and an outer surface extending between said first end and said second end, said first clamp having a bend defining a first portion forming an angle with a second portion, said bend being centrally positioned between said first end and said second end, said first portion being associated with said first end, said second portion being associated with said second end, said outer surface having a plurality of intersecting sides such that said first clamp has a rectangular shape, said plurality of intersecting sides including a bottom side, a first lateral side and a second lateral side, said bottom side resting on the lift platform having said first portion angling upwardly from said lift platform wherein each of said first portion and said second portion are configured to rest against a sidewall of the front tire, said outer surface having a pair of lips each extending laterally away from a respective one of said first lateral side and said second lateral side, each of said lips being aligned with said bottom side such that each of said lips rests on the lift platform, each of said lips having a plurality of fastener holes wherein each of said fastener holes is configured to receive a fastener to secure said first clamp to the lift platform;
a locking unit being attached to the lift platform, said locking unit being spaced from said first clamp on the lift platform, said locking unit being actuatable in a first condition having said locking unit travelling toward said first clamp, said locking unit being actuatable in a second condition having said locking unit travelling away from said first clamp, said locking unit comprising:
a stand having a base and a member angling upwardly from said base, said base resting on the lift platform having said member being vertically oriented on the lift platform, said member having a distal end with respect to said base, said member having an aperture extending through said member, said aperture being positioned adjacent to said distal end, said aperture extending along an axis being oriented perpendicular to an axis extending between said distal end and said base, said aperture having a bounding surface, said bounding surface being threaded, said base having a plurality of holes extending through said base wherein each of said holes in said base is configured to receive a respective fastener for securing said base to the lift platform;
a screw having a primary end, a secondary end and an outside surface extending between said primary end and said secondary end, said screw extending through said aperture having said outside surface threadably engaging said bounding surface of said aperture, said base being oriented such that said secondary end of said screw is directed toward said first clamp;
a drive unit having an input and an output, said output being coupled to said primary end of said screw, said output being in mechanical communication with said input;
a motor being coupled to said input of said drive unit, said output being rotated in a first direction when said motor is actuated into a first condition such that said screw travels through said aperture toward said first clamp, said output being rotated in a second direction when said motor is actuated into a second condition such that said screw travels through said aperture away from said first clamp;
a control being electrically coupled to said motor, said control having a first button and a second button, said motor being actuated into said first condition when said first button is depressed, said motor being actuated into said second condition when said second button is depressed; and
a power cord being electrically coupled to and extending away from said motor, said power cord having a distal end with respect to said motor, said distal end having a male plug being electrically coupled thereto wherein said male plug is configured to be plugged into a power source comprising a female electrical outlet;
a second clamp being coupled to said locking unit, said second clamp moving toward said first clamp when said locking unit is actuated into said first condition wherein said second clamp is configured to compress the front tire of the motorcycle between said first clamp and said second clamp to secure the motorcycle on the lift platform, said second clamp moving away from said first clamp when said locking unit is actuated into said second condition wherein said second clamp is configured to disengage the front tire of the motorcycle thereby facilitating the front tire to roll freely on the lift platform, said second clamp having a first end, a second end and an outer surface extending between said first end and said second end of said second clamp, said second clamp having a bend defining a first portion forming an angle with a second portion, said bend on said second clamp being centrally positioned between said first end and said second end of said second clamp, said first portion of said second clamp being associated with said first end of said second clamp, said second portion of said second clamp being associated with said second end of said second clamp, said outer surface of said second clamp having a plurality of intersecting sides such that said second clamp has a rectangular shape, said plurality of intersecting sides including a first lateral side and a second lateral side; and
a receiver being coupled to said first lateral side of said outer surface of said second clamp, said receiver being centrally positioned between said bend on said second clamp and said first end of said second clamp, said receiver having a distal end with respect to said first lateral side of said outer surface of said second clamp, said distal end of said receiver being open, said distal end of said receiver receiving said secondary end of said screw, said receiver rotatably engaging said secondary end such that said screw is rotatable in said receiver.
